(19) United States
(12) Patent Application Publication
(10) Pub. No.: US 2021/0146600 A1
(43) Pub. Date: May 20, 2021

(54) ROUNDED BEVEL EMBOSSING

(71) Applicant: LEAR CORPORATION, Southfield, MI (US)

(72) Inventors: Naoyuki TANIGUCHI, Tokyo (JP); Rebecca Berger, Kenansville, NC (US); Manabu Sakamoto, Tokyo (JP)

(21) Appl. No.: 16/687,979

(22) Filed: Nov. 19, 2019

(51) Int. Cl. B29C 59/02

(52) U.S. Cl. CPC B29C 59/026; B29D 7/01; B29C 59/022

(57) ABSTRACT

A method for embossing a polymeric sheet with rounded embossments includes a step of providing an embossing system including a platen component and a press component. The press component includes a pressing plate and a plurality of embossing protrusions extending from the pressing plate. The plurality of embossing protrusions are arranged in a predetermined pattern. Advantageously, each embossing protrusion has curved sidewalls with only rounded edges if present. A polymeric sheet is placed on the platen component. The polymeric sheet is contacted with the press component at a sufficient temperature to form embossments on the polymeric sheet. Characteristically, the embossments are depressions in the polymeric sheet having rounded sidewalls and rounded edges

### TECHNICAL FIELD

In at least one aspect, the present invention is related to methods and systems for embossing polymeric sheets with embossments that have rounded edges and sidewall.

### BACKGROUND

Methods for embossing polymeric sheets with decorative embossments are provided in U.S. Pat. Nos. 5,490,890 and 6,514,597.

### SUMMARY

In at least one aspect, a method for embossing a polymeric sheet with rounded embossments is provided. The method includes a step of providing an embossing system including a platen component and a press component. The press component includes a pressing plate and a plurality of embossing protrusions extending from the pressing plate. The plurality of embossing protrusions are arranged in a predetermined pattern. Advantageously, each embossing protrusion has curved sidewalls with only rounded edges if present. A polymeric sheet is placed on the platen component. The polymeric sheet is contacted with the press component at a sufficient temperature to form embossments on the polymeric sheet. Characteristically, the embossments are depressions in the polymeric sheet having rounded sidewalls and rounded edges.

In another aspect, a vehicle seat component incorporating the embossed polymeric sheet formed by the method set forth herein. The vehicle seat component including an upholstery section that includes a polymeric sheet having a plurality of embossments. The embossments are depressions in the polymeric sheet having rounded sidewalls and rounded edges, each rounded sidewall and rounded edge having a radius of curvature greater than 0.5 mm.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1A provides a schematic flowchart of a method of embossing a polymeric sheet with an embossing system acting on discrete polymeric sheets.

FIG. 1B provides a schematic flowchart of a method of embossing a polymeric sheet with an embossing system acting a continuous roll of a polymeric sheet.

FIG. 2A is a schematic of a press component with a plurality of embossing protrusions arranged in an array.

FIG. 2B is a schematic of a press component with a plurality of embossing protrusions arranged in an array with alternating rows being offset.

FIG. 3A is a perspective view of an embossing protrusion having a 4-point star pyramidal structure.

FIG. 3B is a perspective view of an embossing protrusion having a sidewall with a circular or elliptical cross section and a flat top.

FIG. 3C is a perspective view of an embossing protrusion having a elongated structure having a sidewall with a circular or elliptical cross section and a round top.

FIG. 3D is a perspective view of an embossing protrusion having an elongated structure.

FIG. 4 is a perspective view of a vehicle sheet incorporating the embossed polymeric sheet formed by the method associated with the description of FIGS. 1 to 3.

### DETAILED DESCRIPTION

Reference will now be made in detail to compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Throughout this application, where publications are referenced, the disclosures of these publications in their entireties are hereby incorporated by reference into this application to more fully describe the state of the art to which this invention pertains.

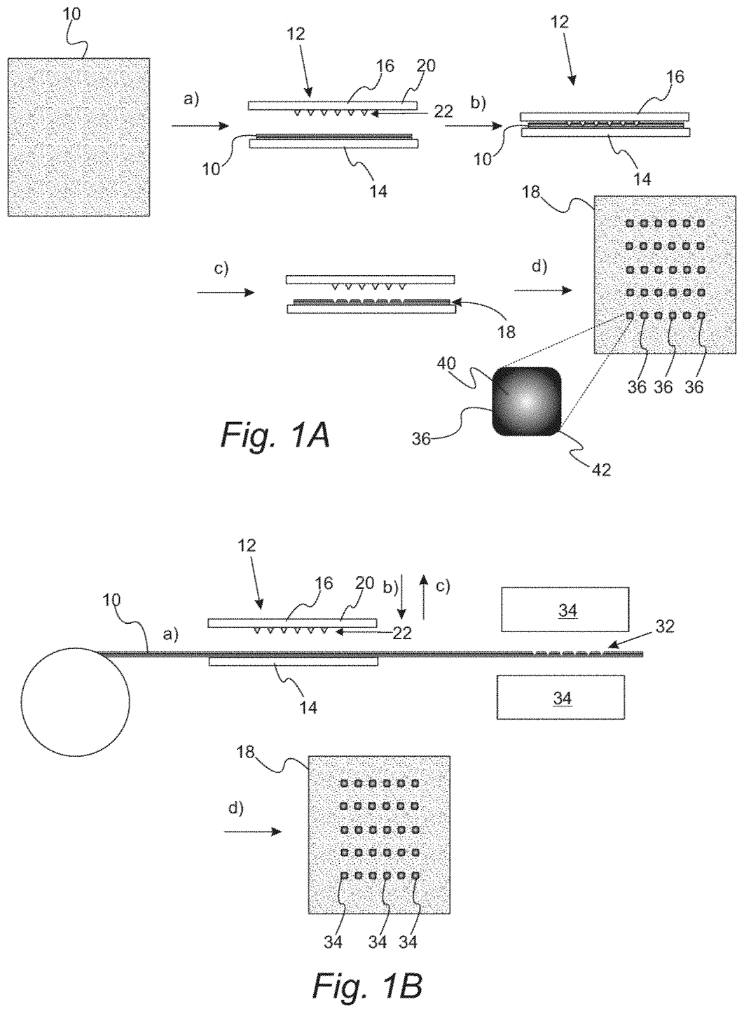

With references to FIGS. 1A and 1B, schematic flowcharts depicting a method for embossing a polymeric sheet are provided. FIG. 1A shows the method as applied to precut sheets while FIG. 1B shows the method applied to a continuous roll of polymeric sheet. With reference to FIG. 1A, pre-cut polymeric sheet 10 is provided to embossing system 12. Embossing system 10 includes platen component 14 and press component 16. Characteristically, press component 16 includes pressing plate 20 with a plurality of embossing protrusions 22 extending from the pressing plate. The plurality of embossing protrusions are arranged in a predetermined pattern. In step a), polymeric sheet 10 is placed on platen component 14. In step b), polymeric sheet 10 is contacted with the press component 16 at a sufficient temperature to form embossments on the polymeric sheet. Typically, platen component 14 and press component 16 are independently at a temperature from about 60° C. to 200° C. In a refinement, platen component 14 and press component 16 are independently at a temperature from about 70° C. to 80° C. One or more heaters (not pictured) can be utilized to heat platen component 14 and press component 16 to the predetermined temperatures. In a further refinement, the temperature of press component 16 is 20 to 40° C. higher than the temperature of platen component 14. In step c), press component 16 is retracted. In step d), embossed sheet 18 is removed.

With reference to FIG. 1B, polymeric sheet 10 is supplied to embossing system 12 from a roll 30 of the polymeric sheet in step a) with a portion of the polymeric sheet resting on platen component 14 and below press component 16. Characteristically, press component 16 includes pressing plate 20 with a plurality of embossing protrusions 22 extending from the pressing plate. The plurality of embossing protrusions are arranged in a predetermined pattern. In step b), polymeric sheet 10 is contacted with the press component 16 at a sufficient temperature to form embossments on the polymeric sheet. As set forth above, platen component 14 and press component 16 are independently at a temperature from about 60° C. to 200° C. In a refinement, platen component 14 and press component 16 are independently at a temperature from about 70° C. to 80° C. In a further refinement, the temperature of press component 16 is 20 to 40° C. higher than the temperature of platen component 14. In step c), press component 16 is retracted. It is clear that polymeric sheet 10 is not moving from roller 30 during steps b) and c). In step d), the resulting embodiments polymeric sheet 32 is cut into discreet embossed polymeric sheets 18 by cutting die 34.

In both of the variations of FIGS. 1A and 1B, embossed polymeric sheet 18 includes embossments 36 formed therein from a plurality of embossing protrusions 22. Characteristically, these embossments 36 will have rounded sidewalls 40 and rounded edges 42 that are complementary to the sides and edges of embossing protrusions 22 as set forth below. In particular, the temperature applied to platen component 14 and press component 16 as well as the duration of the contact between embossing protrusions 22 and the polymeric sheet are sufficient to allow the sidewalls of the embossing protrusions to fully contact the polymeric sheet so that a true complementary embossment is formed. Since embossing protrusion 22 are protrusions, embossments 36 are indentations (e.g., depressions) in polymeric sheet 18.

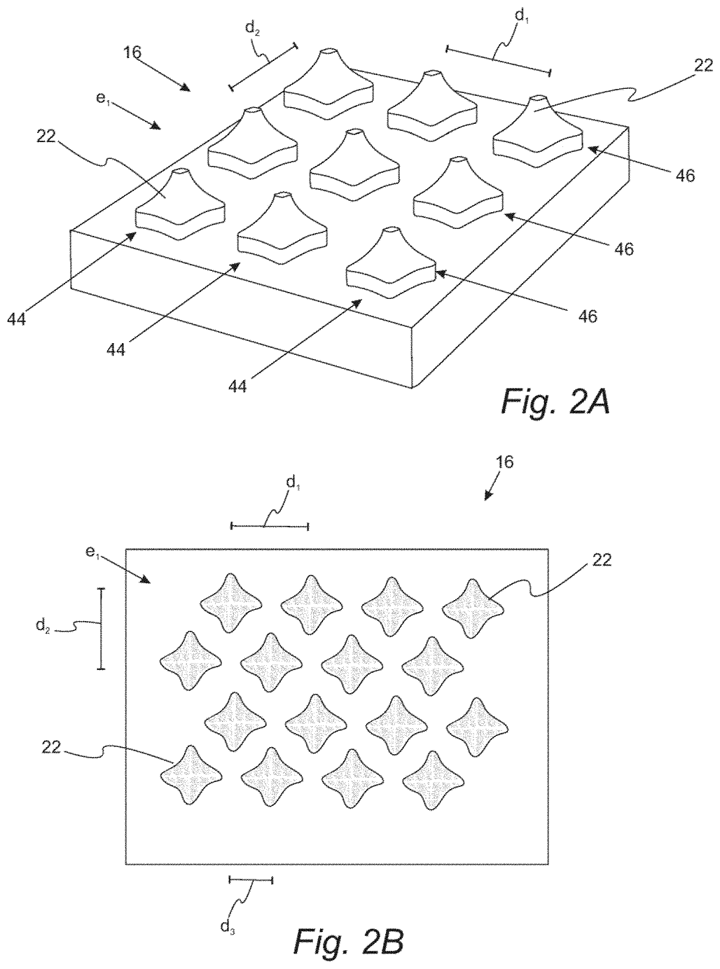

FIGS. 2A and 2B depict press component 16 with the plurality of embossing protrusions 22 arranged in an array. In this context, “array” means that the distributions of protrusions 22 has a pattern, and in particular, a repeating pattern over an extent e₁. In FIG. 2A, the embossing protrusions 22 are distributed with aligned columns 44 and aligned rows 46. Centers of adjacent embossing protrusions are separated by a predetermined distance d₁ and d₂ along perpendicular directions. In FIG. 2B, alternating rows of embossing protrusions are offset by a predetermined distance d₃. In a refinement, d₁ and d₂ are from about 2 to 10 cm and d₃ is from about 1 to 5 cm.

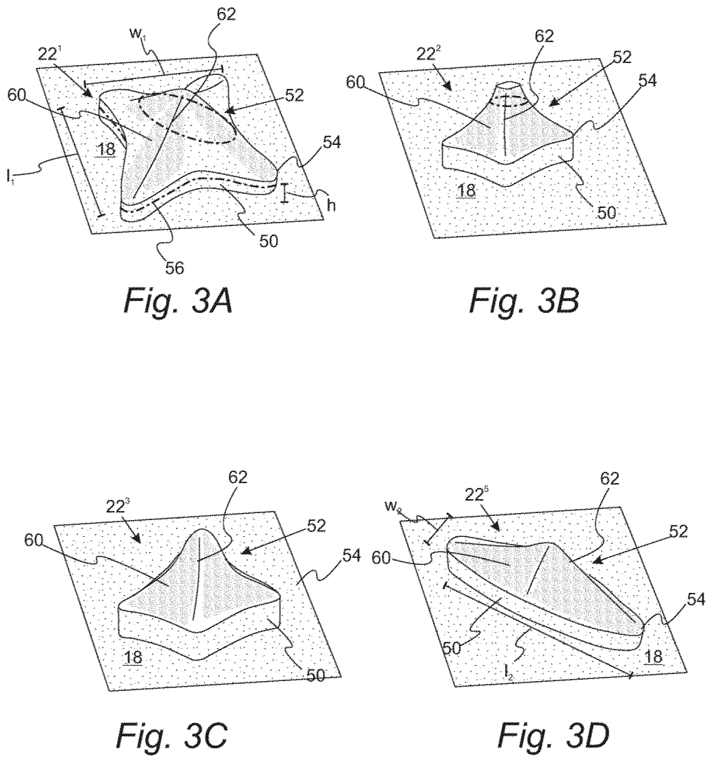

The present invention is not limited by the type of embossing protrusions and the related embossment formed therefrom. FIGS. 3A, 3B, 3C, and 3D depict various non-limiting examples for embossing protrusions 22. In a refinement, a subset of the plurality of embossing protrusions have the design of FIGS. 3A, 3B, 3C, and 3D. FIG. 3A is a perspective view of protrusion 22¹ having a 4 point star pyramidal structure. FIG. 3B is a perspective view of protrusion 22² having a sidewall with a circular or elliptical cross section and a flat top. FIG. 3C is a perspective view of protrusion 22³ having an elongated structure having a sidewall with a circular or elliptical cross section with respect to a plane parallel to the pressing plate and a round top. FIG. 3D is a perspective view of protrusion 22⁴ having an elongated structure.

The embossing protrusions in each of FIGS. 3A, 3B, 3C, and 3D include a pedestal section 50 and a body section 52 extending from the pedestal section. Pedestal section 50 typically has a height from about 0.5 mm to about 20 mm. The radius of curvature for a curve formed by the intersection of the surface of pedestal section 50 and any plane intersecting the pedestal section (e.g., a plan parallel to the surface of pressing plate 18) is greater than, in increasing order of preference, 0.5 mm, 1 mm, 1.5 mm, 2 mm, 3 mm, 4 mm, or 5 mm. These values are particularly relevant at pedestal edge 54 thereby giving the embossment the rounded appearance since edges will have a smaller radius of curvature than non-edge regions. The radius of curvature for a curve as used herein is provided by the following equation:

$${R}_{c} = \frac{{[ 1 + {( \frac{d y}{d x} )}^{2} ]}^{3 / 2}}{\vert \frac{{d}^{2} y}{d {x}^{2}} \vert}$$

where:
R_{c} is the radius of curvature,
x is the independent variable for the equation of a curve in a plane,
y is the dependent variable for the equation of a curve in a plane.

Body section 52 includes one or more sidewalls 60 and optional body edges 62. In a refinement, the radius of curvature for a curve formed by the intersection of the surface of one or more sidewalls 60 and any plane that intersect the sidewalls (e.g. a plane parallel to the surface of pressing plate 18) is greater than, in increasing order of preference, 0.5 mm, 1 mm, 1.5 mm, 2 mm, 3 mm, 4 mm, or 5 mm. In particular, the radius of curvature for this curve at body edges 62 is greater than, in increasing order of preference, 0.5 mm, 1 mm, 1.5 mm, 2 mm, 3 mm, 4 mm, or 5 mm. Moreover, each of pedestal sections 50 have a length l₁ and a width w₁. The examples of FIGS. 3A, 3B, and 3C have a length and width that are approximately equal. In a refinement, length l₁ and width w₁ are each independently from about 3 mm to 5 cm. In should be appreciated, that the embossments 36 of FIG. 1 while also have the same ranges of the radius of curvature for the complementary edges and sidewalls. In the example of FIG. 3D, the length l is greater than width w₁. Typically, in this refinement, length l₁ is from about 3 mm to 10 cm and width w₁ is from about 2 mm to 5 cm.

As set forth above, the method operates on a polymeric sheet. In a refinement, the polymeric sheet is a laminate including two or more layers (e.g., two or more polymeric layers). Typically, the laminate includes a foamed polymeric layer. In particular, the laminate includes a foamed polymeric layer positioned between two polymeric skin layers. In this context, a skin layer means a polymeric layer that is not a foamed layer. Examples of useful polymer for the polymeric skin layers and foam layer include, but are not limited to, polyester sheets and polyether sheets.

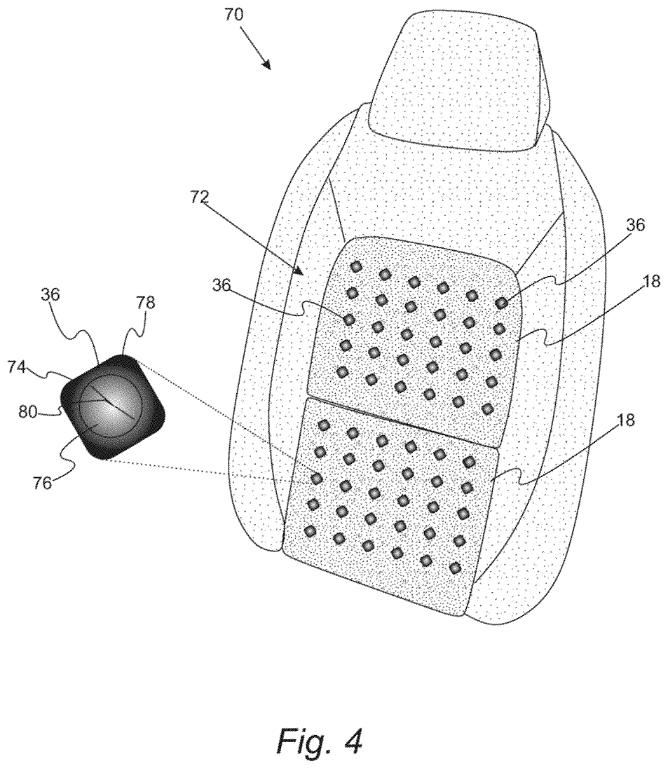

With reference to FIGS. 3 and 4, illustration of the incorporation of the embossed polymeric into a vehicle seat upholstery component is provided. FIG. 4 provides a prospective view of a vehicle seat back incorporating the embossed sheet set forth above. Vehicle seatback 70 includes a section 72 that includes embossed polymeric sheet 18 incorporated in the lumbar section of the seat back. As set forth above, embossments 36 are complementary depressions to the embossing protrusions 22. Embossment 36 includes a sidewall 74 complementary to the surface of pedestal section 50 and sidewall 76 complementary to the surface of body section 52. The radius of curvature for sidewall 74, sidewall 76, and any edges 78, 80 therein will have a radius of curvature greater than, in increasing order of preference 0.5, 1 mm, 1.5 mm, 2 mm, 3 mm, 4 mm, or 5 mm.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
providing an embossing system including a platen component and a press component, the press component including a pressing plate and a plurality of embossing protrusions extending from the pressing plate, the plurality of embossing protrusions being arranged in a predetermined pattern, each embossing protrusion having curved sidewalls with only rounded edges if present;
placing a polymeric sheet on the platen component; and
contacting the polymeric sheet with the press component at a sufficient temperature to form embossments on the polymeric sheet, the embossments being depressions in the polymeric sheet having rounded sidewalls and rounded edges.

2. The method of claim 1 wherein each embossing protrusion includes one or more rounded edges having a radius of curvature greater than 0.5 mm for any curve defined by an intersection of the one or more rounded edges and any plane that intersects the one or more rounded edges.

3. The method of claim 1 wherein each embossing protrusion includes one or more rounded edges having a radius of curvature greater than 1.0 mm for any curve defined by an intersection of the one or more rounded edges and any plane that intersects the one or more rounded edges.

4. The method of claim 1 wherein each embossing protrusion includes a pedestal section and a body section extending from the pedestal section.

5. The method of claim 4 wherein a cross section through the body section parallel to the pressing plate defines a substantially circular cross section or an elliptical cross section.

6. The method of claim 1 wherein the polymeric sheet is a laminate including two or more layers.

7. The method of claim 6 wherein the laminate includes a foamed polymeric layer.

8. The method of claim 6 wherein the laminate includes a foamed polymeric layer positioned between two polymeric skin layers

9. The method of claim 1 wherein the polymeric sheet is a polyester sheet or a polyether sheet.

10. The method of claim 1 wherein the polymeric sheet is precut prior to being placed on the platen component.

11. The method of claim 1 wherein the platen component and the press component are independently at a temperature from about 60° C. to 200° C.

12. The method of claim 1 wherein the polymeric sheet is supplied to an embossing system from a roll of the polymeric sheet.

13. The method of claim 1 wherein centers of adjacent embossing protrusions arc separated by a first predetermined distance and a second predetermined distance along perpendicular directions.

14. The method of claim 1 wherein alternating rows of embossing protrusions are offset by a third predetermined distance.

15. The method of claim 1 wherein at least a subset of the plurality of embossing protrusions have a 4 point star pyramidal structure.

16. The method of claim 1 wherein at least a subset of the plurality of embossing protrusions have an elongated structure with a sidewall with a circular or elliptical cross section and a round top.

17. A vehicle seat component comprising:
an upholstery section that includes a polymeric sheet having a plurality of embossments, the embossments being depressions in the polymeric sheet having rounded sidewalls and rounded edges, each rounded sidewall and rounded edge having a radius of curvature greater than 0.5 mm.

18. The vehicle seat component of claim 17 wherein the vehicle seat component is a seatback.

19. The vehicle seat component of claim 17 wherein the polymeric sheet is a polyester sheet or a polyether sheet.

20. The vehicle seat component of claim 17 wherein the polymeric sheet is a laminate having 2 or more layers.
